(19) United States
(12) Patent Application Publication
(10) Pub. No.: US 2022/0247447 A1
(43) Pub. Date: Aug. 4, 2022

(54) NOTIFICATION RESPONSE CIRCUIT

(71) Applicant: LAPIS SEMICONDUCTOR CO., LTD., YOKOHAMA (JP)

(72) Inventor: KENICHI MORIOKA, YOKOHAMA (JP)

(21) Appl. No.: 17/612,195

(22) PCT Filed: May 27, 2020
(86) PCT No.: PCT/JP2020/020871

§ 371 Date: Nov. 17, 2021

(30) Foreign Application Priority Data
May 28, 2019 (JP) 2019-099099

(51) Int. Cl. H04B 1/59; H04B 5/02

(52) U.S. Cl. CPC H04B 1/59; H02J 50/12; H04B 5/02

(57) ABSTRACT

A notification response circuit includes a reception coil, a characteristic variable circuit connected to the reception coil, and a switch control circuit. The reception coil is configured to generate a current based on an external electromagnetic field. The characteristic variable circuit includes at least two circuits of a variable capacitor circuit, a voltage output circuit, and a variable resistor circuit. The variable capacitor circuit is configured to change a capacitance. The voltage output circuit is configured to change a voltage value between a pair of connection lines disposed between the reception coil and the voltage output circuit according to a voltage value of a reference voltage. The variable resistor circuit is configured to change a resistance value. The switch control circuit selectively switches any of the at least two circuits and performs control to change impedances of the reception coil and a circuit part connected to the reception coil.

### TECHNICAL FIELD

The present invention relates to a notification response circuit disposed in a reception side circuit in short-range wireless communication.

### BACKGROUND ART

Recently, information transmission and electric power transmission using short-range wireless communication (NFC: Near field communication) have been popularly performed. A communication system for the short-range wireless communication includes, for example, a transmission side circuit that generates an electromagnetic field and transmits data and a reception side circuit that operates based on the electromagnetic field generated by the transmission side circuit (for example, Patent Document 1).

In the communication system for short-range wireless communication, as means to perform notification response from the reception side circuit to the transmission side circuit, the reception side circuit has generated an impedance change to change an amount of current flowing the transmission side. The transmission side circuit processes the current change generated at the time as the notification response from the reception side circuit.

Patent Document 1: JP-A-2018-196225

### DISCLOSURE OF THE INVENTION

### Problems to be Solved by the Invention

In order to cause the impedance change in the reception side circuit, it is conceivable to use means, such as switching a matching capacitor, controlling a shunt circuit to switch a clamp voltage, and switching a load resistance.

However, depending on circumstances, for example, a distance between the transmission side circuit and the reception side circuit and/or a frequency of the electromagnetic field, there are some cases that the impedance change is not generated even by using the means described above. For example, points of a frequency at which the impedances are the same at different resistance values are present. Even when the load resistance of the reception side circuit is changed at the frequency, the impedance observed from the transmission side does not change. Therefore, there has been a problem that the transmission side circuit cannot receive the notification response from the reception side circuit in some cases.

The present invention has been made in consideration of the above-described problem, and an object of the present invention is to provide a notification response circuit that allows smooth notification response from a reception side circuit to a transmission side circuit in short-range wireless communication.

### Solutions to the Problems

According to the present invention, a notification response circuit comprising: a reception coil configured to generate a current based on an external electromagnetic field; a characteristic variable circuit that includes at least two circuits of a variable capacitor circuit, a voltage output circuit, and a variable resistor circuit, the variable capacitor circuit being connected to the reception coil, the variable capacitor circuit including a plurality of capacitors and being configured to change a capacitance, the voltage output circuit being configured to change a voltage value between a pair of connection lines disposed between the reception coil and the voltage output circuit according to a voltage value of a reference voltage, the variable resistor circuit including a plurality of resistors and being configured to change a resistance value; and a switch control circuit that selectively switches any of the at least two circuits and performs control to change impedances of the reception coil and a circuit part connected to the reception coil.

### Effects of the Invention

With the notification response circuit of the present invention, smooth notification response from a reception side circuit to a transmission side circuit is possible.

### BRIEF DESCRIPTION OF THE DRAWINGS

FIG. 1 is a block diagram illustrating a configuration of a wireless communication system of this embodiment.

FIG. 2 is a circuit diagram illustrating an extracted configuration of a matching capacitor circuit.

FIG. 3 is a circuit diagram illustrating an extracted configuration of a shunt circuit.

FIG. 4 is a circuit diagram illustrating an extracted configuration of a load resistor circuit.

FIG. 5 is a flowchart depicting operations of a transmission side circuit.

FIG. 6 is a flowchart depicting operations of a reception side circuit.

### DESCRIPTION OF PREFERRED EMBODIMENTS

Preferred embodiments of the present invention will be described in detail below. Note that the same reference numerals are given to substantially identical or equivalent parts in the description in the following embodiments and the accompanying drawings.

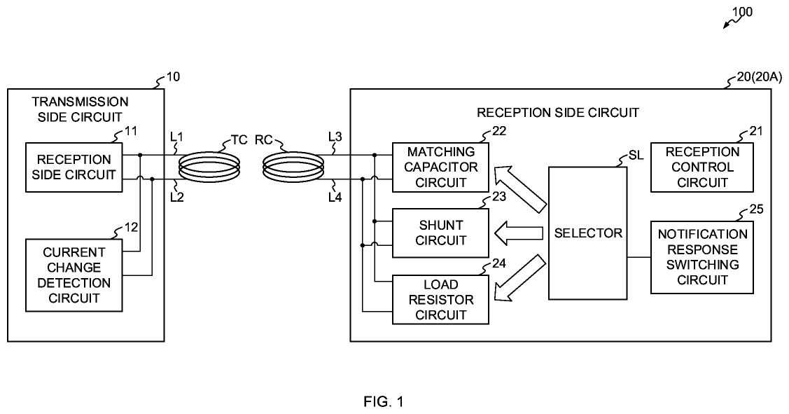

FIG. 1 is a circuit diagram illustrating a configuration of a communication system 100 of this embodiment. The communication system 100 includes a transmission side circuit 10 and a reception side circuit 20. The transmission side circuit 10 is disposed in, for example, a reader-writer of Radio Frequency Identification (RFID). The reception side circuit 20 is, for example, disposed in a passive tag of RFID.

The transmission side circuit 10 and the reception side circuit 20 are communication circuits that perform communications compliant with short-range wireless communication standards using an electromagnetic wave via a transmission coil TC and a reception coil RC. In this embodiment, a case in which an alternating magnetic field at a high frequency (for example, 13.56 MHz) having a constant intensity with the transmission coil TC is formed will be described as an example. The reception coil RC generates an alternating current by performing magnetic field coupling on the alternating magnetic field and supplies respective units in the reception side circuit 20 with the alternating current.

The transmission side circuit 10 transmits information packets via the electromagnetic field generated by the transmission coil TC. For example, the transmission side circuit 10 of this embodiment transmits a notification response request that requests notification response from the reception side circuit 20 as the information packet. The transmission side circuit 10 includes a transmission control circuit 11 and a current change detection circuit 12.

The transmission control circuit 11 controls operations of respective units of the transmission side circuit 10. For example, the transmission control circuit 11 controls transmission/reception of the information packet via the transmission coil TC. The transmission control circuit 11 is connected to the transmission coil TC via lines L1 and L2.

The current change detection circuit 12 is connected to the transmission coil TC via the lines L1 and L2. The current change detection circuit 12 detects a change in a current flowing from the transmission coil TC to the lines L1 and L2, and notifies the transmission control circuit 11 of the detection result.

The reception side circuit 20 is a circuit connected to the reception coil RC. The reception side circuit 20 receives the information packet transmitted from the transmission side circuit 10 based on the magnetic field coupling between the transmission coil TC and the reception coil RC. Note that the reception side circuit 20 may be a circuit that includes, for example, a power reception circuit (not illustrated), and operates by a supply of electric power from the transmission side circuit 10 via the electromagnetic field generated by the transmission coil TC.

In response to the notification response request from the transmission side circuit 10, the reception side circuit 20 changes circuit characteristics of a circuit part (for example, a circuit part 20A in the reception side circuit 20) connected to the reception coil RC to perform notification response to the transmission side circuit 10.

For example, in response to the notification response request transmitted from the transmission side circuit 10, the reception side circuit 20 of this embodiment changes impedances (hereinafter referred to as an impedance on the reception side) of the reception coil RC and the circuit part connected to the reception coil RC. This changes the intensity of the magnetic field between the transmission coil TC and the reception coil RC, and the current flowing the lines L1 and L2 of the transmission side circuit 10 changes. The transmission side circuit 10 detects the change in the current as the notification response from the reception side circuit 20. That is, the reception side circuit 20 of this embodiment constitutes the notification response circuit that performs the notification response from the reception side to the transmission side in the short-range wireless communication together with the reception coil RC.

The reception side circuit 20 includes a reception control circuit 21, a matching capacitor circuit 22, a shunt circuit 23, a load resistor circuit 24, and a notification response switching circuit 25. Each of the matching capacitor circuit 22, the shunt circuit 23, and the load resistor circuit 24 is connected to the reception coil RC via lines L3 and L4.

The reception control circuit 21 is a control circuit that controls the reception of the information packet from the transmission side circuit 10. The reception control circuit 21 controls operations of the respective units of the reception side circuit 20. For example, the reception control circuit 21 controls the notification response switching circuit 25 to cause operations of the notification response process to be performed. The reception control circuit 21 has a function that determines whether the electromagnetic field formed between the reception coil RC and the transmission coil TC has changed (for example, a change in the intensity of the magnetic field).

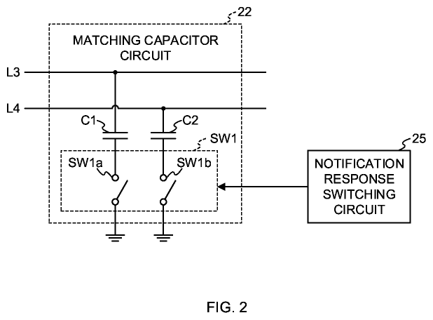

FIG. 2 is a circuit diagram illustrating an extracted configuration of the matching capacitor circuit 22. The matching capacitor circuit 22 includes a changeover switch SW1a and a changeover switch SW1b (a switching unit SW1 illustrated in FIG. 2) and a capacitor C1 and a capacitor C2.

The changeover switch SW1a is a changeover switch that has one end grounded and the other end switchable whether to be connected to the capacitor. The changeover switch SW1a switches the connection according to control by the notification response switching circuit 25.

The changeover switch SW1b is a changeover switch that has grounded one end and switches whether the other end is connected to the capacitor C2. The changeover switch SW1b switches the connection according to control by the notification response switching circuit 25.

The capacitor C1 and the capacitor C2 are capacitors having mutually different capacitances. The capacitor C1 has one end grounded via the changeover switch SW1a, and the other end connected to the line L3. The capacitor C2 has one end grounded via the changeover switch SW1b and the other end connected to the line L4. For example, according to the switching of the changeover switches SW1a and SW1b, any of the capacitor C1 and the capacitor C2 is grounded. For example, the notification response switching circuit 25 may perform control so as to turn off both of the changeover switches SW1a and SW1b.

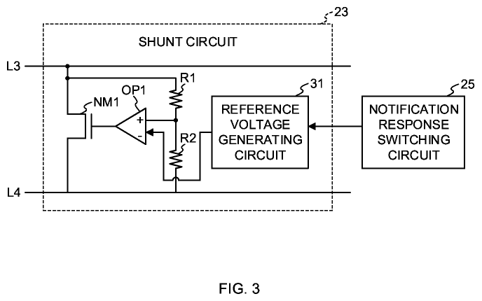

FIG. 3 is a circuit diagram illustrating an extracted configuration of the shunt circuit 23. The shunt circuit 23 is connected to a rectifier circuit (not illustrated) that rectifies a current flowing the lines L3 and L4 from the reception coil RC via the lines L3 and L4. The shunt circuit 23 includes a transistor NM1, an operational amplifier OP1, a resistor R1, a resistor R2, and a reference voltage generating circuit 31.

The transistor NM1 is, for example, constituted of an N channel type MOS transistor. The transistor NM1 has a source connected to the line L4 and a drain connected to the line L3.

The operational amplifier OP1 has a non-inverting input terminal connected to a connection node between the resistor R1 and the resistor R2, and an output terminal connected to a gate of the transistor NM1. To an inverting input terminal of the operational amplifier OP1, a reference voltage output from the reference voltage generating circuit 31 is supplied.

The resistor R1 has one end connected to the line L3. The resistor R2 has one end connected to the line L4. The respective other ends of the resistor R1 and the resistor R2 are connected to one another and connected to the non-inverting input terminal of the operational amplifier OP1. That is, to the non-inverting input terminal of the operational amplifier OP1, a voltage found by proportionally dividing the voltages of the lines L3 and L4 by the resistors R1 and R2 is supplied.

The reference voltage generating circuit 31 generates the reference voltage and supplies it to the non-inverting input terminal of the operational amplifier OP1. Then, the reference voltage generating circuit 31 switches the voltage value of the reference voltage according to control by the notification response switching circuit 25.

The shunt circuit 23 is a circuit that compares the voltage found by proportionally dividing the voltages of the lines L3 and L4 by the resistors R1 and R2 with the reference voltage so as to output a constant voltage (hereinafter referred to as a clamp voltage). In this embodiment, since the control by the notification response switching circuit 25 switches the voltage value of the reference voltage generated by the reference voltage generating circuit 31, the voltage value of the clamp voltage switches according to this.

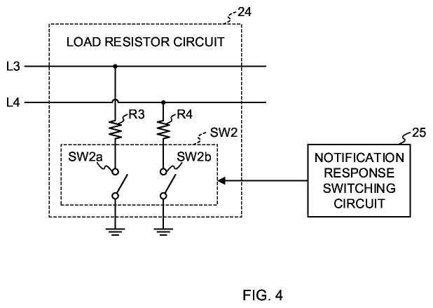

FIG. 4 is a circuit diagram illustrating an extracted configuration of the load resistor circuit 24. The load resistor circuit 24 includes a changeover switch SW2a and a changeover switch SW2b (a switching unit SW2 illustrated in FIG. 2) and a resistor R3 and a resistor R4.

The changeover switch SW2a is a changeover switch that has one end grounded and the other end switchable whether to be connected to the resistor R3. The changeover switch SW2a switches the connection according to control by the notification response switching circuit 25.

The changeover switch SW2b is a changeover switch that has one end grounded and the other end switchable whether to be connected to the resistor R4. The changeover switch SW2b switches the connection according to control by the notification response switching circuit 25.

The resistor R3 and the resistor R4 are load resistors having mutually different resistance values. The resistor R3 has one end grounded via the changeover switch SW2a and the other end connected to the line L3. The resistor R4 has one end grounded via the changeover switch SW2b and the other end connected to the line L4. For example, according to the switching between the changeover switches SW2a and SW2b, any of the resistor R3 and the resistor R4 is grounded. For example, the notification response switching circuit 25 may perform control so as to turn off both of the changeover switches SW2a and SW2b.

Thus, the matching capacitor circuit 22 changes the capacitor of itself, the shunt circuit 23 changes the clamp voltage between the lines L3 and L4, and the load resistor circuit 24 changes the resistance value of the load resistor connected to the reception coil RC. That is, the matching capacitor circuit 22, the shunt circuit 23, and the load resistor circuit 24 are variable characteristic circuits that change the circuit characteristics of the circuit part connected to the reception coil RC.

The notification response switching circuit 25 is a circuit that selectively performs switching control on any of the matching capacitor circuit 22, the shunt circuit 23, and the load resistor circuit 24 via a selector SL to switch between a capacitor clamp voltage and a load resistance. The switching control is performed for smooth notification from the reception side circuit 20 to the transmission side circuit 10. This will be described below.

For example, switching the capacitor in a matching capacitor circuit 22 usually changes the impedance on the reception side. However, depending on circumstances of the distance between the transmission coil TC and/or the reception coil RC and the frequency, there is a point (a condition) where the impedance hardly changes. Similarly, even when the clamp voltage is switched in the shunt circuit 23 and the load resistance is switched in the load resistor circuit 24, the impedance on the reception side hardly changes in some cases. When the impedance does not change, the communication state between the transmission side circuit 10 and the reception side circuit 20 (for example, the intensity of the magnetic field between the transmission coil TC and the reception coil RC) does not change, and the transmission side circuit 10 does not detect the change in the current, and therefore the transmission side circuit 10 cannot receive the notification response from the reception side circuit 20.

The notification response switching circuit 25 of this embodiment is disposed to avoid the state and allow the smooth notification response from the reception side circuit 20 to the transmission side circuit 10. That is, the notification response switching circuit 25 appropriately switches the circuit as the controlled target and generates the change in the impedance using any of the variable characteristic circuits, thus ensuring the smooth notification response.

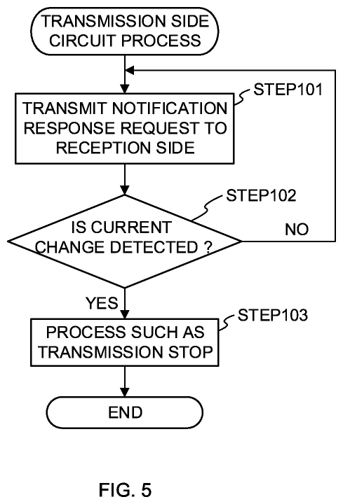

Next, a process routine of the notification response process in the communication system 100 will be described. First, the operations of the transmission side circuit 10 will be described with reference to the flowchart in FIG. 5.

The transmission control circuit 11 in the transmission side circuit 10 transmits the notification response request to the reception side circuit 20 via the electromagnetic field generated by the transmission coil TC (STEP 101).

When the notification response to the notification response request is operated by the reception side circuit 20 and the impedance changes, the magnetic field between the transmission coil TC and the reception coil RC changes, and the current flowing through the lines L1 and L2 changes. The current change detection circuit 12 detects the change in the current.

The transmission control circuit 11 determines whether the change in the current flowing the lines L1 and L2 is detected by the current change detection circuit 12 (STEP 102). For example, when the current value changes by a predetermined value or more, the transmission control circuit 11 determines that the change in the current is detected. When it is determined that the change in the current is not detected (STEP 102: NO), the process returns to STEP 101, and the notification response request to the reception side circuit 20 is performed again.

On the other hand, when it is determined that the change in the current is detected (STEP 102: YES), the transmission control circuit 11 performs a process, such as transmission stop (STEP 103), and terminates the operation for the notification response process.

In a case where the change in the current is not detected in spite of performing the notification response request by the predetermined number of times or an elapse of the predetermined period, it may be configured such that the process does not return to STEP 101 to terminate the process as time-out.

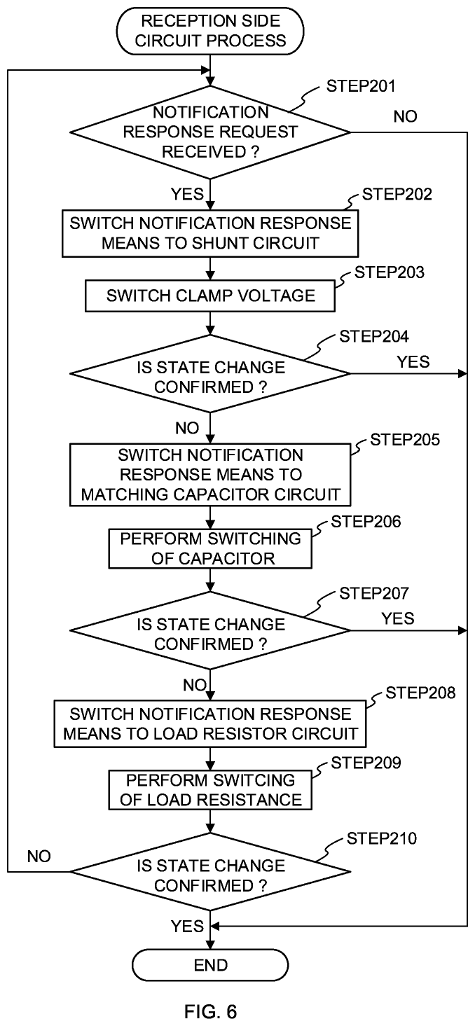

Next, the operation of the reception side circuit 20 will be described with reference to the flowchart in FIG. 6.

First, the reception control circuit 21 in the reception side circuit 20 determines whether the notification response request has been received from the transmission side circuit 10 (STEP 201). When it is determined that the notification response request is not received (STEP 201: NO), the process is terminated.

On the other hand, the notification response request is determined as being received (STEP 201: YES), the reception control circuit 21 controls the notification response switching circuit 25 to perform the operation of the notification response process.

The notification response switching circuit 25 selects the shunt circuit 23 as a characteristic variable circuit used for the notification response by the switching control using the selector SL (STEP 202). The shunt circuit 23 performs switching of the clamp voltage according to the control by the notification response switching circuit 25 (STEP 203).

The reception control circuit 21 determines whether the electromagnetic field between the transmission coil TC and the reception coil RC changes (that is, the state change has been confirmed) by the switching of the clamp voltage by the shunt circuit 23 (STEP 204). For example, in a case where the impedance on the reception side changes by the switching of the clamp voltage, the intensity of the magnetic field between the transmission coil TC and the reception coil RC changes. For example, when the magnetic field intensity changes by the predetermined value or more, the reception control circuit 21 determines that the state change is confirmed. When the reception control circuit 21 determines that the state change is confirmed (STEP 204: YES), the reception control circuit 21 regards it as the notification response being transmitted to the transmission side circuit 10 and terminates the process.

On the other hand, when the state change is not confirmed (STEP 204: NO), the notification response switching circuit 25 selects the matching capacitor circuit 22 as the characteristic variable circuit used for the notification response by the switching control (STEP 205). The matching capacitor circuit 22 performs switching of the capacitor according to the control by the notification response switching circuit 25 (STEP 206).

The reception control circuit 21 determines whether the switching of the capacitor in the matching capacitor circuit 22 (that is, the change in the capacitance) changes the electromagnetic field between the transmission coil TC and the reception coil RC (that is, whether the state change is confirmed) (STEP 207). Similarly to STEP 203, for example, when the magnetic field intensity changes by the predetermined value or more, the reception control circuit 21 determines that the state change is confirmed. When the reception control circuit 21 determines that the state change is confirmed (STEP 207: YES), the reception control circuit 21 regards it as the notification response being transmitted to the transmission side circuit 10 and terminates the process.

On the other hand, when the state change is not confirmed (STEP 207: NO), the notification response switching circuit 25 selects the load resistor circuit 24 as the characteristic variable circuit used for the notification response by the switching control (STEP 208). The load resistor circuit 24 performs switching of the load resistance according to the control by the notification response switching circuit 25 (STEP 209).

The reception control circuit 21 determines whether the electromagnetic field between the transmission coil TC and the reception coil RC changes by the switching of the load resistance (that is, the state change has been confirmed) (STEP 210). Similarly to STEP 203, for example, when the magnetic field intensity changes by the predetermined value or more, the reception control circuit 21 determines that the state change is confirmed. In a case where the state change is not confirmed (STEP 210: NO), the process returns to STEP 201 again, and the reception side circuit 20 waits for the reception of the notification response request from the transmission side circuit 10.

On the other hand, when the reception control circuit 21 determines that the state change is confirmed (STEP 210: YES), the reception control circuit 21 regards it as the notification response being transmitted to the transmission side circuit 10 and terminates the notification response process.

In FIG. 6, whether the switching is performed as the notification response means is determined in the order of the shunt circuit 23, the matching capacitor circuit 22, and the load resistor circuit 24, but any given order of the determination in the notification response means is used.

As described above, in the reception side circuit 20 (namely, the notification response circuit) of this embodiment, while the reception control circuit 21 confirms the change in the electromagnetic field, the reception control circuit 21 controls the notification response switching circuit 25, and the notification response switching circuit 25 switches the characteristic variable circuit as the notification response means (the matching capacitor circuit 22, the shunt circuit 23, and the load resistor circuit 24). Thus, even under the condition in which the impedance does not change in the reception side in certain notification response means, switching the notification response means allows changing the impedance using another notification response means.

Therefore, the notification response circuit of this embodiment allows the smooth notification response from the reception side to the transmission side in the short-range wireless communication.

Note that the present invention is not limited to the ones described in the embodiments. For example, in the embodiments, the configuration in which the reception side circuit 20 includes the matching capacitor circuit 22, the shunt circuit 23, and the load resistor circuit 24, and the notification response switching circuit 25 selectively performs the switching control on them to perform the notification response has been described. However, all of three of them are not necessarily disposed. It is only necessary that at least two of the notification response means may be provided, and the notification response means can be selectively switched. Alternatively, four or more notification response means including means other than them may be disposed.

### DESCRIPTION OF REFERENCE SIGNS

100 Communication system
10 Transmission side circuit
11 Transmission control circuit
12 Current change detection circuit
20 Reception side circuit
21 Reception control circuit
22 Matching capacitor circuit
23 Shunt circuit
24 Load resistor circuit
25 Notification response switching circuit
26 Reference voltage generating circuit

1. A notification response circuit comprising:
a reception coil configured to generate a current based on an external electromagnetic field;
a characteristic variable circuit that includes at least two circuits of a variable capacitor circuit, a voltage output circuit, and a variable resistor circuit, the variable capacitor circuit being connected to the reception coil, the variable capacitor circuit including a plurality of capacitors and being configured to change a capacitance, the voltage output circuit being configured to change a voltage value between a pair of connection lines disposed between the reception coil and the voltage output circuit according to a voltage value of a reference voltage, the variable resistor circuit including a plurality of resistors and being configured to change a resistance value; and
a switch control circuit that selectively switches any of the at least two circuits and performs control to change impedances of the reception coil and a circuit part connected to the reception coil.

2. The notification response circuit according to claim 1, wherein
an impedance value changes by the change in the capacitance, the voltage value, or the resistance value, and
when a change in intensity of the electromagnetic field caused by the change in the impedance is less than a predetermined value, the switch control circuit performs the switching of the at least two circuits.

3. The notification response circuit according to claim 1, wherein
the notification response circuit responds to a signal from an external circuit based on an intensity of the electromagnetic field changed by the change in an impedance value.

4. The notification response circuit according to any one of claims 1, wherein
the variable capacitor circuit further includes at least one first switching element that switches connection of the plurality of capacitors.

5. The notification response circuit according to claim 1, wherein
the voltage output circuit is a shunt circuit connected to the reception coil via the pair of connection lines, and the voltage output circuit compares the voltage value of the reference voltage with the voltage value of a voltage between the pair of connection lines to output a constant voltage between the pair of connection lines.

6. The notification response circuit according to claim 1, wherein
the variable resistor circuit further includes at least one second switching element that switches connection of the plurality of resistors.
